(19) United States
(12) Patent Application Publication
(10) Pub. No.: US 2015/0034625 A1
(43) Pub. Date: Feb. 5, 2015

(54) COOKING APPLIANCE AND METHOD FOR CONTROLLING THE SAME

(71) Applicant: EIKA, S. COOP., ETXEBERRIA (ES)

(72) Inventors: Daniel DE LOS TOYOS LOPEZ, EIBAR (ES); Jon Endika AZPIRITXAGA ZALBIDE, DURANGO (ES)

(73) Assignee: EIKA, S. COOP., ETXEBERRIA (ES)

(21) Appl. No.: 14/448,084

(22) Filed: Jul. 31, 2014

(30) Foreign Application Priority Data
Aug. 2, 2013 (ES) 201331213

(51) Int. Cl. H05B 1/02; H05B 3/68

(52) U.S. Cl. CPC H05B 1/0266; H05B 3/68
USPC 219/482

(57) ABSTRACT

A control method is provided for controlling a burner of a cooking appliance. According to one implementation the method includes the selection of a desired first power level of the burner within a first discrete set of possible power levels and the selection of a second power level within a second discrete set of power levels, the power released by the burner being the power corresponding to a combination of the selected first and second power levels, the values of the second discrete set of power levels being such that the released power by the burner is between the selected first power level and the next consecutive greater power level of the first set of power levels. A cooking appliance capable of implementing the control method is also provided.

### CROSS-REFERENCE TO RELATED APPLICATIONS

This application relates to and claims the benefit and priority to Spanish Patent Application No. P201331213, filed Aug. 2, 2013.

### TECHNICAL FIELD

The present invention relates to a control method for controlling a cooking appliance and a cooking appliance for implementing it, particularly, a home cooking appliance comprising at least one cooking area.

### BACKGROUND

Home appliances comprising at least one radiant burner and control means for controlling the power released from the radiant burner are known. Most of the control systems known in the prior state of the art are complicated and perform non-continuous power control.

EP1699267A2 discloses an electrical cooking appliance the control system of which includes cooking mode selection means through which the user can predetermine a cooking mode, for example normal, simmer or frying mode, and suitable cooking value selection means so that the user can choose a cooking temperature within a predetermined range of temperatures for each cooking mode.

### SUMMARY OF THE DISCLOSURE

According to one implementation a control method is provided that comprises a first step in which the user selects a desired first power level within a first discrete set of possible power levels for a burner located in a cooking area of a cooking appliance. The burner may be a quasi-continuous burner. The method further comprises a second step in which the user selects a second power level within a second discrete set of power levels, the power generated by the burner once the user has selected the second power level being a combination of the power corresponding to the first and second power levels. The values of the second discrete set being such that the power released in the cooking area is comprised between the selected first power level and to the next consecutive power lever of the first set of power levels. As a result, fine power control can be obtained in any power level which is particularly important at low power levels where small variations in the percentage of power release can cause a stable boiling to turn into unstable boiling.

A cooking appliance adapted for implementing the aforementioned control method may comprises at least one cooking area and associated burner(s), main selection means through which a user selects the first power level within the first discrete set of possible power levels, and at least one display device on which the user may view the selected first power level.

The main selection means permits the user to select a second power level within a second discrete set of power levels, the power released in the cooking area being the power corresponding to the combination of the selected first and second power levels, the values of the second discrete set of power levels are such that the released power is comprised between the selected first power level and a consecutive power level, immediately thereafter, within the first set of power levels.

These and other advantages and features will become evident in view of the drawings and the detailed description.

### BRIEF DESCRIPTION OF THE DRAWINGS

FIG. 1 shows a schematic view of a cooking appliance according to one implementation.

FIG. 2 shows a table containing the values corresponding to the power levels according to one implementation.

### DETAILED DESCRIPTION

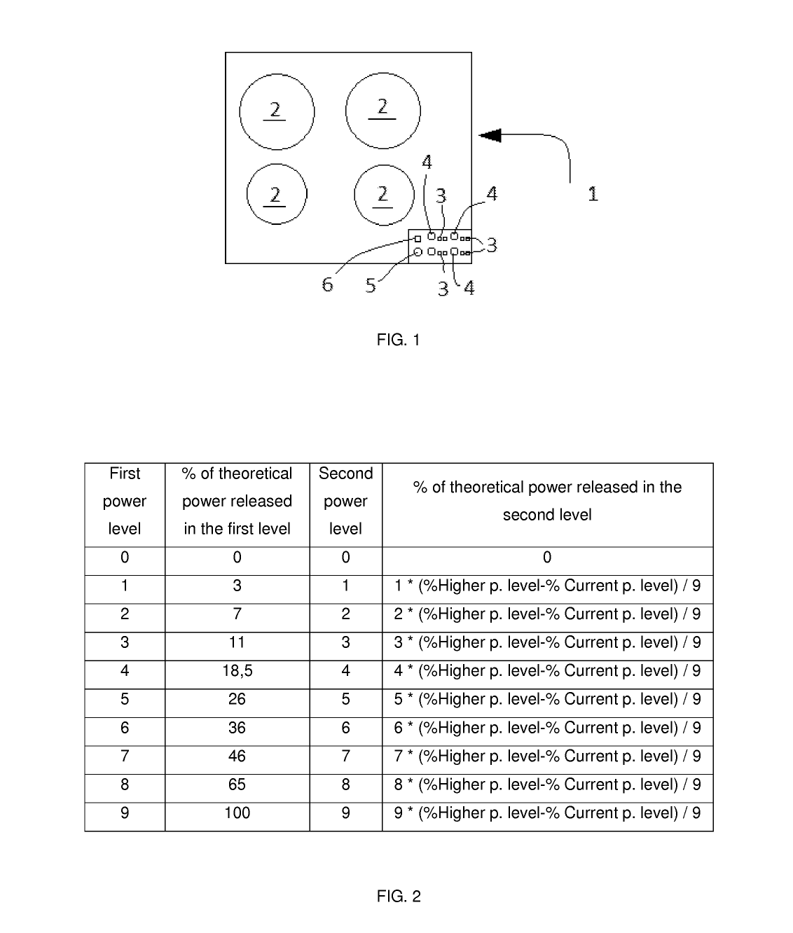

FIG. 1 schematically shows a cooking appliance 1 according to one implementation. The cooking appliance 1 includes at least one cooking area 2, selection means 3 through which a user may select at least one power level and a display device 4 where the user may view the previously selected power level. The display device 4 may comprise any of a number of configurations and according to one implementation is a multi-segment display device preferably having seven segments.

According to some implementations the cooking appliance 1 comprises radiant electrical burners that are arranged below a vitroceramic cooktop, not depicted in the drawings, and which define the respective cooking areas 2. It is appreciated, however, that the cooking appliance may comprise other types of burners, such as, for example, induction burners or other heating elements known in the state of the art.

The burner(s) associated to cooking area 2 generally operates in a coarse power control mode. Therefore, once a user turns on the cooking appliance 1 by actuating an ON/OFF switch 5, he/she selects a first power level through the selection means 3. The first power level can be selected within a first discrete set of possible power levels for a particular cooking area 2. Use of a first discrete set of power levels for operating the cooking appliance in a coarse mode is known in the state of the art. According to one implementation the first discrete set preferably comprises the power levels comprised between 0 through 9. The table shown in FIG. 2 shows theoretical percentages of power released from a burner of at least one of the cooking areas 2 for each power level.

When the user wants to perform fine power control, for example, when he/she wants to cook food in a liquid keeping it just at or a little below the boiling point (e.g. which may correspond to a simmering) where small variations in the percentage of power released from the burner may result in a controlled boiling without splashing to turn to an unstable boiling characterized by splashing. In other situations small variations in the percentage of power release from the burner may result in an insufficient cooking system without effective boiling. To avoid the aforementioned unwanted results, the user may select a second power level within a second discrete set of power levels by operating the burner in fine power control mode. The power released by the burner in the corresponding cooking area 2 is the combination of the released powers corresponding to the first and second selected power levels, such that the power released by the burner is between the selected first power level and the next consecutive greater power level of the first set of power level. According to some implementations, the power released by the burner corresponds with the sum of released powers corresponding to the selected first and second power levels.

According to one implementation, the second discrete set of power levels is defined depending on the difference between the current first power level and a power level immediately after the selected level of the current first power level, as shown in the table of FIG. 2. In particular, for each first power level chosen, the second discrete set of power levels is formed by values resulting from dividing the difference by the first power level chosen and the power level immediately after it between the number of values forming the second discrete set of power levels (nine in the example of FIG. 2) and multiplying it by the level corresponding to the second power level selected. For example, as shown in FIG. 2, if the user selects a first power level 5 corresponding with a theoretical power release of the burner of 26%, and the user then selects a second power level 2 by actuating the fine power control mode, he/she would add 2.22% (the calculation being 2×(36−26)/9) of the theoretical value corresponding to the first power level 5 to the theoretical power release of the burner, a total theoretical power release of 28.22% being obtained.

According to another implementation, the second discrete set of power levels is formed by percentage points over the established first power level. That is, if, for example, the first discrete set of possible power levels in the cooking area 2 is formed by ten correlative values 0, 10%, 20%,3 0% . . . till 100%, the second discrete set of power levels may be formed by the correlative values from 0, 1%, 2%, 3% . . . till 9%. Thus, if a user selects a level of 2.7, he/she would be selecting a first power level of 2 which corresponds with a theoretical release of burner power of 20% incremented by 7% because the user has chosen 7 as the second power level for fine regulation, a theoretical total power release of 27% being obtained.

According to another implementation the first discrete set of power levels may be the same as in the previous example, and the second discrete set of power levels may be formed by five discrete correlative values (0%,2%,4%,6%,8%), when the user selects a level of 4.4, for example, he/she will be selecting a first power level of 4 corresponding to a theoretical power release of the burner of 40% and a second power level of 4 corresponding to a theoretical power release of the burner of 6%, thus the total release of power for a level of 4.4 would be of 46%.

Finally, in either case, if the user selects a first power level of 9, the theoretical power release of the burner will be 100% thus the user will not have to select a second power level in such a case.

Turning again to FIG. 1, the cooking appliance 1 may include an activation device 6 independent from the selection means 3, the activation device 6 being configured for activating/deactivating the fine power control mode when the user actuates the activation device 6. The activation device 6 may be a touch device.

According to some implementations the user can activate the fine power control mode by actuating the selection means 3 for a specific time. According to some implementations the time is greater than or equal to 3 seconds. According to some implementations the user can deactivate the fine control mode by pressing the selection means again for, for example greater than or equal to 3 seconds.

According to some implementations the selection means 3 allows for selecting both the first release power level and the second release power level. While, according to other implementations the selection means 3 allows for selecting only the first release power level and the cooking appliance 1 includes an auxiliary selection means that allows the user to select the second release power level. According to some implementations the auxiliary selection means is available to select the second release power level once the fine power control mode has been activated, whereas in other implementations fine cooking control is initiated by the user simply acting on the auxiliary selection means.

According to some implementations the selection means 3 comprises one or more touch buttons that allow increasing or reducing the selected power level. Such selection means 3 are known in the state of the art so they will not be described in detail.

To allow the user to visually and quickly distinguish whether the appliance is in coarse control mode or fine control mode, the first power level and the second power level selected by the user may be shown on the display device 4 with different durations of the visual indication. Therefore, when the cooking appliance 1 operates in fine power control mode, the display device 4 may show the value of the selected first level and of the selected second level alternately. According to some implementation the duration of the visual indication of the first level is longer than the duration of the visual indication of the second level. According to one implementation the duration of the first power level is about 2 seconds and the duration of the second power level is about 0.5 seconds.

What is claimed is:

1. A method for controlling an electrical burner of a cooking appliance, the method comprising:
a first step in which a desired first power level of the burner within a first discrete set of possible power levels is selected,
a second step in which a second power level within a second discrete set of power levels is selected, the power released by the burner being the power corresponding to a combination of the first and second power levels, the values of the second discrete set of power levels being such that the released power by the burner is between the selected first power level and the next consecutive greater power level of the first set of power levels.

2. A method according to claim 1, wherein the power released by the burner corresponds with the sum of the selected first and second power levels.

3. A method according to claim 1, wherein the cooking appliance includes a first selector for selecting the first power level and before selecting the second power level the first selector is acted upon for at least a minimum period of time in order to activate a fine power control mode.

4. A method according to claim 1, wherein the cooking appliance includes a first selector for selecting the first power level and before selecting the second power level a fine power control mode independent from the first selector.

5. A method according to claim 1, wherein each of the second discrete set of power levels is formed by a percentage point over the established first power level.

6. A method according to claim 1, wherein the second discrete set of power levels is defined based on the difference between the current first power level and the next consecutive greater power level of the first set of power levels.

7. A cooking appliance comprising:
an electrical burner adapted to heat a cooking area on a surface of the cooking appliance,
a first selector through which a user may select a first power level for the electrical burner within a first discrete set of possible power levels; and
a second selector though which the user may select a second power level within a second discrete set of power levels so that the power to be released in the burner corresponds to a combination of the selected first and second power levels, the values of the second discrete set of power levels being such that the released power by the burner is between the selected first power level and the next consecutive greater power level of the first set of power levels.

8. A cooking appliance according to claim 7, wherein the first selector and second selector are the same.

9. A cooking appliance according to claim 7, wherein the burner is adapted to release power in the cooking area in correspondence with the sum of the selected first and second power levels.

10. A cooking appliance according to claim 7, further comprising at least one display device that is configured to display a value of the selected first power level and/or the value of the selected second power level.

11. A cooking appliance according to claim 7, further comprising an ON/OFF fine power control mode selector independent from the first selector, the second power level selectable only upon the fine power mode selector being in the ON position.

12. A cooking appliance according to claim 10, wherein the at least one display is configured to alternately display the selected first power level and the selected second power level.

13. A cooking appliance according to claim 12, wherein the at least one display is configured to display the first selected power level for a first duration and to display the second selected power level for a second duration, the first duration being greater than the second duration.
